(19) United States
(12) Patent Application Publication
(10) Pub. No.: US 2023/0333563 A1
(43) Pub. Date: Oct. 19, 2023

(54) PATH PLANNING FOR AUTOMATIC MOWERS

(71) Applicant: Clark Equipment Company, West Fargo, ND (US)

(72) Inventors: Michael Schmidt, Bismarck, ND (US); Dylan Stokosa, Lincoln, ND (US); Dalton Michael Ramirez, Whittier, CA (US); Declan O′neill, Seattle, WA (US); Cristian Gonzalez, Hawthorne, CA (US); Garrick Jensen, Anaheim, CA (US); Henry Morton, Portland, OR (US); Joseph Q. Zales, Carmichael, CA (US); Liam Chalk, Washington, DC (US); Sidney Taylor, Reno, NV (US); Victor Shia, Upland, CA (US)

(21) Appl. No.: 18/303,275

(22) Filed: Apr. 19, 2023

Related U.S. Application Data
(60) Provisional application No. 63/332,548, filed on Apr. 19, 2022.

(51) Int. Cl. G05D 1/02; A01D 34/00; G05D 1/00

(52) U.S. Cl. CPC G05D 1/0219; A01D 34/008; G05D 1/0088; G05D 1/0214; G05D 2201/0208

(57) ABSTRACT

Methods and systems are provided for controlling automatic travel of a power machine, including a mower, along a work path associated with a geographical area. As unknown objects are detected along a current work path, new work paths can be determined for a remaining portion of the geographical area (e.g., an area not yet mowed).

### CROSS-REFERENCE TO RELATED APPLICATIONS

This application claims priority to U.S. Provisional Pat. Application No. 63/332,548, filed Apr. 19, 2022, the entirety of which is incorporated herein by reference.

### BACKGROUND

This disclosure is directed toward power machines. More particularly, this disclosure is related to power machines for mowing operations, including zero-turn mowers (i.e., mowers that can turn with a zero-turn radius) configured to perform automatic mowing operations (e.g., automated mowing operations). Power machines, for the purposes of this disclosure, include any type of machine that generates power to accomplish a particular task or a variety of tasks. One type of power machine is a work vehicle. Work vehicles are generally self-propelled vehicles that have a work device that can be operated to perform a work function. For example, mowers can include a mower deck with one or more rotatable blades that can be operated to cut grass, brush, or other material as the travels over terrain. Other work vehicles include loaders (including mini-loaders), excavators, utility vehicles, tractors (including compact tractors), and trenchers, to name a few examples.

The discussion above is merely provided for general background information and is not intended to be used as an aid in determining the scope of the claimed subject matter.

### SUMMARY

Some examples described herein relate to path planning, and, more particularly, to controlling a power machine to determine a work path for a mowing event (or other work task) and then automatically traveling along the work path to advance the mowing event (or other work task) toward completion.

Some examples provide a method of controlling a power machine, implemented by an electronic processor. A first work path can be determined for a mowing event associated with a geographical area. The power machine can be controlled to perform the mowing event by traveling along at least a portion of the first work path. A first unknown object can be detected along the first work path after traveling a first portion of the first work path, wherein the first portion is associated with a first subsection of the geographical area. A second work path for continuing the mowing event can be determined, the second work path associated with a second subsection of the geographical area remaining after the power machine travels along the first portion of the first work path. The power machine can be controlled to continue performing the mowing event by traveling along at least a portion of the second work path.

In some examples, a method can further include detecting a second unknown object along the second work path after traveling a second portion of the second work path, wherein the second portion is associated with a third subsection of the geographical area. A third work path can be determined for continuing the mowing event, the third work path associated with a third subsection of the geographical area remaining after the power machine travels along the first portion of the first work path and the second portion of the second work path. The power machine can be controlled to continue performing the mowing event by traveling along at least a portion of the third work path.

In some examples, determining a first work path can include accessing a user input associated with at least one of: a known object within the geographical area, a boundary parameter for the geographical area, a starting point of the mowing event, an ending point of the mowing event, or at least one parameter of the mowing event.

In some examples, determining a first work path can include decomposing a geographical area into a first set of cells, wherein each cell included in the first set of cells does not include an object, and determining a first path based on the first set of cells.

In some examples, determining the first work path can include determining an order of the first set of cells based on a shortest path between each cell included in the first set of cells. The first path can be determined based on the order of the first set of cells. Controlling the power machine to perform the mowing event by traveling along the first work path can include controlling the power machine to travel along the first work path based on the order of the first set of cells, wherein the power machine travels in a first direction along the first work path by traveling successively to each cell included in the first set of cells based on the order of the first set of cells.

Determining the first path based on the first set of cells can include determining an intracellular path for each cell included in the first set of cells. Controlling the power machine to perform the mowing event by traveling along the first work path can include controlling the power machine to perform the mowing event by traveling along each intracellular path associated with the first set of cells based on the order of the first set of cells. Determining the intracellular path can include determining a pattern of travel within a cell included in the first set of cells such that the power machine entirely traverses the cell.

In some examples, detecting a first unknown object can be based on sensor data associated with the power machine that is received while the power machine travels along the first work path.

In some examples, a power machine (e.g., a mower) can include a main frame, a work element coupled to the main frame, a plurality of electrical actuators coupled to the main frame, an electrical power source configured to power the plurality of electrical actuators, and an electronic controller in communication with the plurality of electrical actuators. The electronic controller can be configured to control the power machine to perform a mowing event associated with a geographical area by traveling along at least a portion of a first work path determined for the geographical area. The electronic controller can be configured to detect, based on receiving sensor signals, a first unknown object along the first work path after the power machine travels a first portion of the first work path, wherein the first portion is associated with a first subsection of the geographical area. The electronic controller can be configured to determine a second work path for continuing the mowing event, the second work path associated with a second subsection of the geographical area remaining after the power machine travels along the first portion of the first work path. The electronic controller can be configured to control the power machine to continue performing the mowing event by traveling along at least a portion of the second work path.

In some examples, the electronic controller can be further configured to: access user input associated with the geographical area and determine, based on the user input, the first work path for the mowing event associated with the geographical area.

In some examples, the electronic controller can be configured to determine the first work path for the mowing event associated with the geographical area by: decomposing the geographical area into a first set of cells, wherein each cell included in the first set of cells is object free; and determining the first path based on the first set of cells.

In some examples, the electronic controller can be configured to determine the first work path for the mowing event associated with the geographical area by: determining an order of the first set of cells based on a shortest path between each cell included in the first set of cells; and determining the first path based on the order of the first set of cells. The electronic controller can be configured to control the power machine to perform the mowing event by traveling along the first work path by controlling the power machine to travel along the first work path based on the order of the first set of cells. The power machine can travel in a first direction along the first work path by traveling successively to each cell included in the first set of cells based on the order of the first set of cells.

In some examples, the electronic controller can be configured to determine the first path based on the first set of cells by determining an intracellular path for each cell included in the first set of cells.

In some examples, the electronic controller can be configured to control the power machine to perform the mowing event by controlling the power machine to travel along each intracellular path associated with the first set of cells, based on the order of the first set of cells.

In some examples, the electronic controller can be configured to determine the second work path for continuing the mowing event by: decomposing the second subsection of the geographical area into a second set of cells, wherein each cell included in the second set of cells is object free, and determining the second path based on the second set of cells.

In some examples, the electronic controller can be configured to determine the second work path for continuing the mowing event by: determining an order of the second set of cells based on a shortest path between each cell included in the second set of cells, and determining the second path based on the order of the second set of cells.

In some examples, the electronic controller can be configured to detect a second unknown object along the second work path after traveling a second portion of the second work path, wherein the second portion is associated with a third subsection of the geographical area. The electronic controller can be configured to determine a third work path for continuing the mowing event, the third work path associated with a third subsection of the geographical area remaining after the power machine travels along the first portion of the first work path and the second portion of the second work path. The electronic controller can be configured to control the power machine to continue performing the mowing event by traveling along at least a portion of the third work path.

In some examples, the third subsection of the geographical area can be smaller than the second subsection of the geographical area and the second subsection of the geographical area can be smaller than the first subsection of the geographical area.

In some examples, the first subsection of the geographical area can include the entirety of the geographical area.

Some examples provide a mower that includes a main frame, a power source, a cutting assembly coupled to the main frame and configured to be powered by the power source for cutting operations. One or more drive motors can be coupled to the main frame and configured to be powered by the power source to move the mower over terrain during cutting operations. A radar system can be arranged to monitor an area around the mower. An electronic controller in communication with the one or more drive motors and the radar system can be configured to control the power machine to perform a mowing event associated with a geographical area by traveling along at least a portion of a first work path determined for the geographical area. The electronic controller can be configured detect, based on receiving signals from the radar system, a first unknown object along the first work path after the power machine travels a first portion of the first work path, wherein the first portion is associated with a first subsection of the geographical area. The electronic controller can be configured to determine a second work path, after detecting the first unknown object, for continuing the mowing event beyond the first unknown object, the second work path associated with a second subsection of the geographical area remaining after the power machine travels along the first portion of the first work path. The electronic controller can be configured control the power machine to continue performing the mowing event by traveling along at least a portion of the second work path.

In some examples, the first work path and the second work path collectively route the mower to mow an entirety of the geographical area, excluding known obstacles and designated avoidance zones.

This Summary and the Abstract are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure can be advantageously practiced.

FIG. 2 is a perspective view showing generally a front of a power machine in the form of a zero-turn mower on which embodiments disclosed in this specification can be advantageously practiced.

FIG. 3 is a block diagram illustrating components of a hydraulic power system of a loader such as the mower of FIG. 2.

FIG. 4 schematically illustrates a system for controlling a power machine according to some embodiments.

FIG. 5 schematically illustrates the power machine included in the system of FIG. 4 according to some embodiments.

FIG. 6 schematically illustrates a controller of the power machine according to some embodiments.

FIG. 7 is a flowchart illustrating a method of controlling a power machine using the system of FIG. 4 according to some embodiments.

FIG. 8 schematically illustrates an example geographical area decomposed into a set of cells according to some embodiments.

FIG. 9 schematically illustrate an example shortest path between the set of cells for the geographical area of FIG. 8 according to some embodiments.

FIG. 10 schematically illustrates an example intracellular path for a cell of a geographical area according to some embodiments.

FIG. 11 is a graph of the lines included in the intracellular path of FIG. 10 being joined by Dubins curves according to some embodiments.

FIGS. 12A-12B illustrate an example grid map of a geographical area according to some embodiments.

FIG. 13 schematically illustrates an example architecture according to some embodiments.

### DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As noted above, some power machines can be configured to perform automatic operations. For example, power machines configured for mowing operations (e.g., zero-turn mowers) can be configured to accomplish various automatic mowing operations. In some contexts, it may be useful to allow operators to customizably identify a path of travel for automatic operations, and in particular to allow operators to customizably identify a work path to complete a mowing event (e.g., to execute mowing operations for a particular geographical area).

Some embodiments described herein can provide improved systems and methods for determining work paths for power machines, and, in particular, can provide improved systems and methods for determining work paths for one or more mowing events. For example, a mobile user device or other input system can be used to receive user input associated with a geographical area, and the received user input can be used to define a work path for one or more mowing events. To complete a mowing event, a power machine can then be automatically controlled to travel along the work path. In some embodiments, as the power machine travels along the work path, an unknown object may be detected. In response to detecting the unknown object, the embodiments described herein may determine a new work path for the remaining portion of the geographical area (e.g., a portion of the geographical area not yet travelled by the power machine when the unknown object is detected). The process of determining a new work path may be recursively performed. For example, for each newly detected unknown object, the embodiments described herein may determine a new work path based on a remaining portion of the geographical area.

As used herein, unless otherwise specified or limited, “unknown object” indicates an object of any type or size (including non-terrain objects and terrain features) that was not previously recognized or fully specified by a relevant control system. For example, some unknown objects can be objects in a geographical area that are not yet represented in a virtual representation of the geographical area that is being used by a control system to navigate a power machine in or around the geographical area. As another example, some unknown objects can be objects that are present, but not fully specified, in a virtual representation of a geographical area (e.g., as probable object locations, objects with uncertain boundaries, etc.). Typically, therefore, data can be received by a control device from sensors of various types (e.g. LIDAR data, radar data, etc.) to further specify unknown objects. For example, radar data can be received and interpreted by a control device to identify entire objects (or parts thereof) that were not previously represented as being within a relevant geographical area (e.g., a mapped area for automated travel), to identify updated boundaries or other properties of objects that were previously specified within the geographical area, etc. However, unknown objects can also be detected in other ways, including based on user input, transmissions from external mapping or remote-control systems, etc.

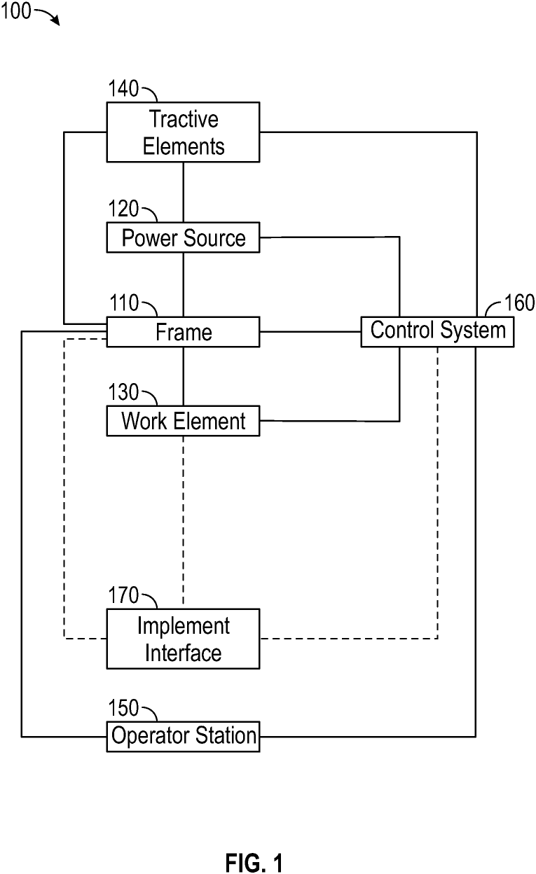

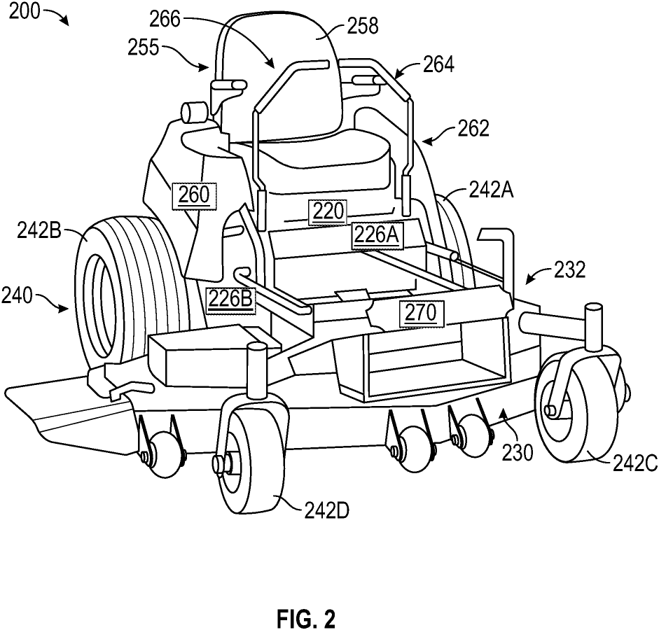

Embodiments described herein relate to controlling a power machine for determining (e.g., learning) a work path for accomplishing a mowing event and automatically traversing the work path to accomplish the mowing event. These concepts can be practiced on various power machines, as will be described below. A representative power machine on which the embodiments can be practiced is illustrated in diagram form in FIG. 1 and one example of such a power machine is illustrated in FIG. 2 and described below before any embodiments are disclosed. For the sake of brevity, only one power machine is discussed. However, as mentioned above, the embodiments below can be practiced on any of a number of power machines, including power machines of different types from the representative power machine shown in FIG. 2. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power. In some examples, a power machine can be a self-propelled mower, including a mower with a work element configured as a mower deck with one or more rotating blades, and additional work elements configured as separately controllable right- and left-side drive elements to allow for independent drive control of the left and right sides of the traction system for the mower.

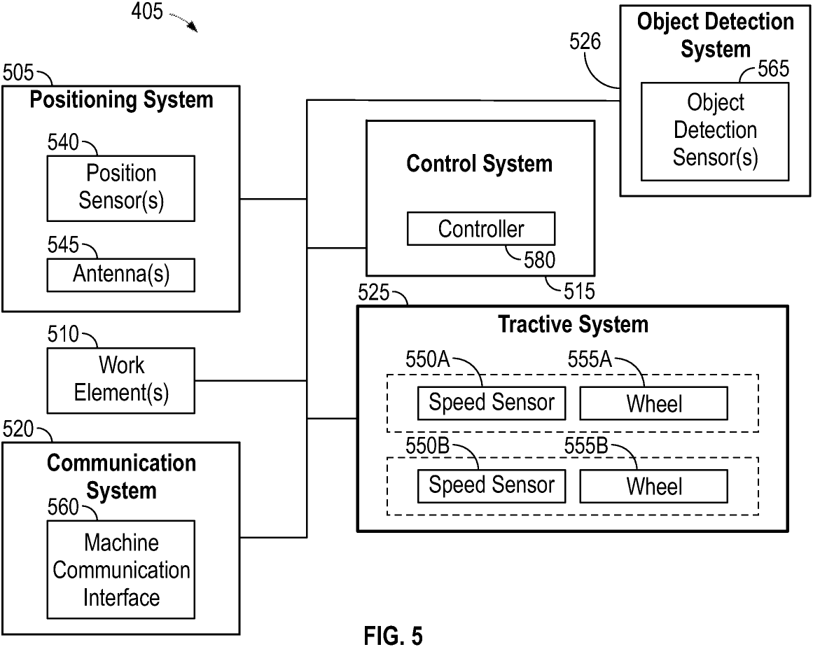

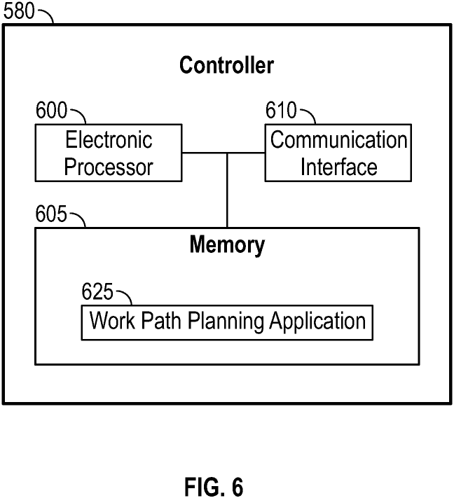

FIG. 1 is a block diagram that illustrates the basic systems of a power machine 100, which can be any of a number of different types of power machines and upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks (for example, at least in part in response to control signals provided by an operator). For example, the control system 160 can be an integrated or distributed architecture of one or more processor devices and one or more memories that are collectively configured to receive operator input or other input signals (e.g., sensor data) and to output commands accordingly for power machine operations. The control system 160 is described in greater detail below with respect to FIGS. 5 and 6.

Certain work vehicles have work elements that can perform a dedicated task. For example, some work vehicles have a mower deck that can be attached to a main frame of the work vehicles in various ways (e.g., as an implement attached to a lift arm). Cutting elements of the mower deck can then be controlled (e.g., to control speed of one or more rotating blades) or the mower deck can be otherwise manipulated (e.g., moved relative to the main frame of the power machine) to perform mowing or other tasks.

Some work vehicles may be able to accept other implements by disassembling a current implement/work element combination and reassembling with another implement in place of the original. Generally, work vehicles are intended to be used with a wide variety of implements and can have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130, or may include more complex mechanisms or structures. In some embodiments, the implement interface 170 can be a pinned connection that secures a mower deck to a movable support structure so that the support structure can be moved relative to a main frame of the power machine to adjust a height (or other orientation) of the mower deck.

The frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

The frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160 (e.g., a system of electronic, hydraulic, electro-hydraulic, or other control devices), which in turn selectively provides power to the elements that are capable of using the power to perform a work function. Power sources for power machines typically include an engine such as an internal combustion engine and a power conversion system such as a mechanical transmission or a hydraulic system that can convert the output from an engine into a form of power that is usable by a work element. Other types of power sources can be incorporated into power machines, including electrical sources or a combination of power sources, known generally as hybrid power sources.

FIG. 1 shows a single work element designated as a work element 130, but various power machines can have any number of work elements. Work elements are typically attached to the frame of the power machine and movable with respect to the frame when performing a work task. In some embodiments, as also discussed above, work elements can include mower decks or other similar equipment. In some embodiments, work elements can include lift arm assemblies or other similar systems. In addition, tractive elements 140 are a special case of work element in that their work function is generally to move the power machine 100 over a support surface. The tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame. In some power machines, such as zero-turn mowers, one or more caster wheels or similar devices can be used along with rigidly mounted (as opposed to pivotally mounted) tractive elements to assist with turning by rotating in response to an uneven application of power (in magnitude or direction) on one side of the machine relative to the other.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments, operator positions or neither, may be capable of being operated remotely (i.e. from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e. remote from both the power machine and any implement to which is it coupled) that is capable of controlling at least some of the operator-controlled functions on the power machine.

FIG. 2 illustrates a mower 200, which is one particular example of a power machine of the type illustrated in FIG. 1 where the embodiments discussed below can be advantageously employed. The mower 200 is one particular example of the power machine 100 illustrated broadly in FIG. 1 and discussed above. To that end, features of the mower 200 described below include reference numbers that are generally similar to those used in FIG. 1. For example, the mower 200 is described as having a frame 210, just as power machine 100 has the frame 110.

The mower 200 is shown as a zero-turn riding lawn mower, but it could also be a differently configured riding lawn mower, or a walk-behind or push-type lawn mower. For the purposes of this discussion, a zero-turn mower is a mower capable of executing a turn with a zero-turn radius (i.e., the mower is capable of rotating about a vertical axis through the center of the machine to execute up to a 360 degree turn). For the sake of readability, the discussion below will discuss turns and refer to them as zero-turns, even though some turns may be performed with a non-zero-turn radius. Correspondingly, the description herein of the mower 200 with references to FIG. 2 provides an illustration of the environment in which the embodiments discussed below can be practiced, and this description should not be considered limiting especially as to the description of features of the mower 200 that are not essential to the disclosed embodiments. Such features may or may not be included in power machines other than mower 200 upon which the embodiments disclosed below may be advantageously practiced. Unless specifically noted otherwise, embodiments disclosed below can be practiced on a variety of power machines, with the mower 200 being only one of those power machines. For example, some or all of the concepts discussed below can be practiced on many other types of work vehicles such as various other mowers, as well as loaders, excavators, trenchers, and dozers, to name but a few examples.

The mower 200 includes the frame 210 that supports a power system 220 that can generate or otherwise provide power for operating various functions on the power machine. The frame 210 also supports a work element in the form of a mower deck 230 that is powered by the power system 220 and that can perform various work tasks (e.g., cutting at different blade speeds or deck heights). As the mower 200 is a work vehicle, the frame 210 also supports a tractive system 240, which is also powered by a power system 220 and can propel the power machine over a support surface. In particular, in the illustrated example, the tractive system 240 includes powered wheels 242A, 242B, as further discussed below, as well as un-powered casters 242C, 242D, which are capable of rotation about a vertical or substantially vertical axis to assist with steering of the mower. The casters 242C, 242D will rotate in response to uneven application of power to the powered wheels 242A, 242B (in terms of magnitude or direction) to cause the mower to turn without skidding despite not having a control system dedicated solely to steering the mower.

A deck support assembly 232 supports the deck 230 relative to the frame 210 and can be configured for selective adjustment to provide different cutting heights, angles, etc. for the deck 230, as well as for selective removal of the deck 230 or installation of additional or alternative work elements (e.g., other mower decks, ducts, and other material handling devices for cut plant material, etc.). The deck 230 can include one or more rotatable blades (not shown) or other cutting assembly (not shown), which can be controlled (e.g., collectively or individually) to cut grass or other material, and which can be powered by hydraulic, electronic, or mechanical connections to the power system 220.

As a riding lawn mower, the mower 200 includes an operator station 255 supported on the frame 210, from which an operator can manipulate various control devices to cause the mower 200 to perform various work functions. In the illustrated example, in particular, the operator station 250 includes an operator seat 258, as well as the various operation input devices 262 in communication with a control system 260 (e.g., a hydraulic control system, or an electronic control system including an electronic hub controller and other distributed controllers that are electronically in communication with the hub controller). The input devices 262 generally allow an operator to control tractive and workgroup operations, so that the mower 200 can be directed to move over terrain and selectively cut grass or other plants along the terrain (or otherwise executed desired work operations).

In some case, the input devices 262 can allow for tractive control of the mower 200. For example, the input devices 262 can include left- and right-side control levers 264, 266 that can be independently moved by an operator to direct, respectively, rotation of left- and right-side drive motors 226A, 226B for independent commanded rotation of left- and right-side tractive elements (e.g., the drive wheels 242A, 242B, as shown). In some cases, the levers 264, 266 can directly control delivery of hydraulic or other power. In some cases, the levers 264, 266 can indirectly control power delivery, including by adjusting a pilot flow for a powered hydraulic system of the mower 200 or by providing electronic signals that direct control of hydraulic, electronic, or other power delivery systems by way of one or more intervening hydraulic or electronic controllers included in the control system 260. Further, other configurations are possible for operator input devices, including configurations with different types of control levers that an operator can manipulate to control various machine functions. In some configurations, the operator input devices 262 can include a joystick (e.g., only a single electronic joystick for tractive operations), a steering wheel, buttons, switches, levers, sliders, pedals and the like, which can be stand-alone devices such as hand operated levers or foot pedals, or can incorporated into hand grips or display panels, and can sometimes include programmable input devices.

As generally noted above, actuation of operator input devices can generate signals in the form of electrical signals, hydraulic signals, mechanical signals, or a combination thereof. Signals generated in response to operator input devices are provided to various components on the power machine for controlling various functions on the power machine. Among the functions that are controlled via operator input devices on the mower 200 are operational functions of the tractive system 240, the mower deck 230, other implements (not shown) including various other attachments (not shown), or a combination thereof.

In some cases, the control system 260 can be configured to operate without input from operator input devices 262 for one or more operations. For example, the control system 260 can be configured for automatic control of certain operations of the mower 200 or can include wireless communication capabilities so as to receive control commands or other relevant data from remotely located (i.e., not mechanically tethered) and other systems, as described in greater detail below.

Mowers can sometimes include other human-machine interfaces, including display devices that are provided in the operator station 255 to give indications of information relatable to the operation of the power machines in a form that can be sensed by an operator, such as, for example, audible or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such as walk behind mowers for example, may not have a cab nor an operator compartment, nor a seat. The operator position on such mowers is generally defined relative to a position where an operator is best suited to manipulate operator input devices.

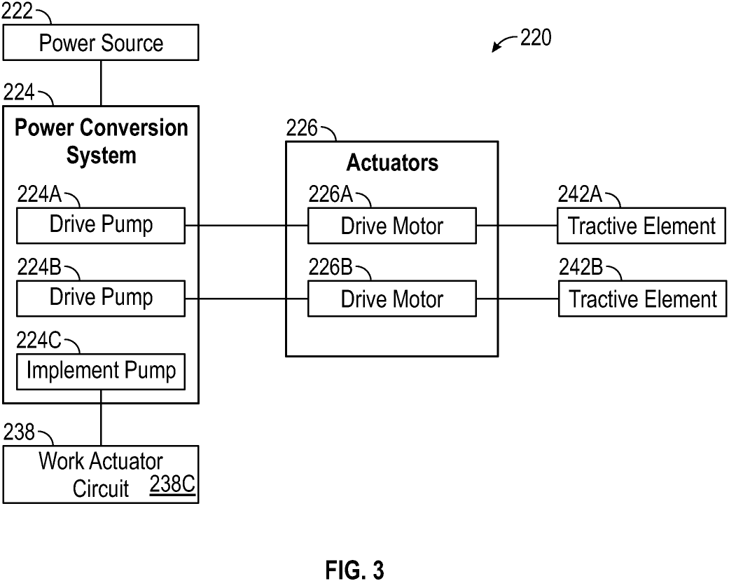

FIG. 3 illustrates an example of a power system 220 in more detail for a hydraulically powered system. Broadly speaking, the power system 220 includes one or more power sources 222 that can generate or store power for operating various machine functions. On the mower 200, the power system 220 includes an internal combustion engine. Other power machines can include electric generators, rechargeable or replaceable batteries, various other power sources or any combination of power sources that can provide power for given power machine components. The power system 220 also includes a power conversion system 224, which is operably coupled to the power source 222. The power conversion system 224 is, in turn, coupled to one or more actuators 226, which can perform a function on the power machine. Power conversion systems in various power machines can include various components, including mechanical transmissions, hydraulic systems, electric motors, and the like. In a hydraulically powered example, the power conversion system 224 of the mower 200 can include hydrostatic drive pumps 224A, 224B, which provide a power signal to drive motors 226A, 226B, respectively. The drive motors 226A, 226B in turn are each operably coupled to a respective tractive element 242A, 242B (e.g., the wheels 242A, 242B as illustrated in FIG. 2). The hydrostatic drive pumps 224A, 224B can be mechanically, hydraulically, or electrically coupled to operator input devices (or otherwise in communication with the control system 260) to receive actuation signals for controlling the drive pump. The power conversion system 224 also includes an implement pump 224C, which can be driven by the power source 222 to provide pressurized hydraulic fluid to a work actuator circuit 238 for operation of a work actuator 239 (e.g., one or more motors for rotation of the blades of the deck 230). The work actuator circuit 238 can include valves and other devices to selectively provide pressurized hydraulic fluid to the various work actuators. In addition, the work actuator circuit 238 can be configured to provide pressurized hydraulic fluid to work actuators on an attached implement.

As also noted above, in some cases, actuators of a power machine (e.g., the mower 200) can be electrically powered. Correspondingly, in some cases, the power conversion system 224 may include electronic or other devices configured for transmission of current to, and general control of, one or more electric motors included in the actuators 226 (e.g., left- and right-side drive motors) and one or more electric motors of non-tractive work elements (e.g., electronic motors included on the deck 230 to power rotation of cutting blades).

The description of the power machine 100 and the mower 200 herein is provided for illustrative purposes, to provide illustrative environments on which the embodiments discussed below can be practiced. While the embodiments discussed can be practiced on a power machine such as is generally described by the power machine 100 shown in the block diagram of FIG. 1 and, more particularly, on a mower such as the zero-turn mower 200, unless otherwise noted or recited, the concepts discussed below are not intended to be limited in their application to the environments specifically described above.

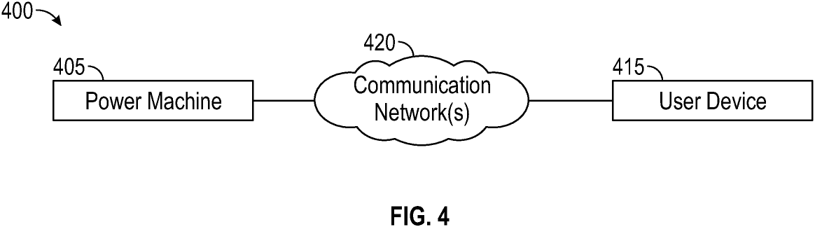

FIG. 4 illustrates a system 400 for controlling a power machine according to some embodiments. In the illustrated example, the system 400 includes a power machine 405 (for example, the power machine 100 of FIG. 1 or the mower 200 of FIG. 2) and a user device 415 (e.g., a portable computing device, such as a tablet computer, a smart telephone, a smart wearable, or other suitable computing device). For example, in some embodiments, the user device 415 is a remote-control device for the power machine 405 such that an operation (via the user device 415) may control one or more operator-controlled functions on the power machine 405. In some embodiments, the system 400 includes fewer, additional, or different components than illustrated in FIG. 4 (e.g., multiple power machines or user devices).

As illustrated in FIG. 4, the power machine 405 and the user device 415 communicate over one or more wired or wireless communication networks 420. Portions of the communication networks 420 may be implemented using a wide area network, such as the Internet, a local area network, such as Bluetooth® network or Wi-Fi, and combinations or derivatives thereof. (Bluetooth is a registered trademark of Bluetooth SIG, Inc. in the United States or other jurisdictions.) In some embodiments, additional communication networks may be used to allow one or more components of the system 400 to communicate. Also, in some embodiments, components of the system 400 may communicate directly as compared to through a communication network 420 and, in some embodiments, the components of the system 400 may communicate through one or more intermediary devices not shown in FIG. 4.

FIG. 5 schematically illustrates the power machine 405 according to some embodiments. In the example illustrated in FIG. 5, the power machine 405 includes a positioning system 505, one or more work elements 510 (for example, the work elements 130, as described above), a control system 515 (for example, the control system 160, as described above), a communication system 520, a tractive system 525, and an object detection system 526. The positioning system 505, the work element(s) 510, the control system 515, the communication system 520, the tractive system 525, and the object detection system 526 communicate over one or more communication lines or buses. The power machine 405 may include additional, fewer, or different components than those illustrated in FIG. 5 in various configurations and may perform additional functionality than the functionality described herein. For example, the power machine 405 may include additional, similar, or different components, systems, and functionality as described above with respect to the power machine 100 of FIG. 1 and the mower 200 of FIG. 2. In some cases, as also discussed below, the work elements 510 can include a mower deck or other mowing implement.

The positioning system 505 is configured to collect (e.g., detect) position data associated the power machine 405, such as, for example, position data associated with (e.g., specifying) a current position of the power machine 405. In some embodiments, the positioning system 505 is configured to collect position data of the power machine 405 in real-time (or near-real time). As illustrated in FIG. 5, the positioning system 505 may include one or more position sensors 540 configured to collect position data associated with the power machine 405. In some embodiments, the positioning system 505 includes components for interoperation with a global navigation satellite system (“GNSS”), such as, for example, a global positioning system (“GPS”). Accordingly, in some embodiments, the positioning system 505 includes one or more additional components related to implementing or leveraging GPS data. For example, as illustrated in FIG. 5, the positioning system 505 may include one or more antennas 545 (including, for example, one or more corresponding receivers) configured to receive GPS data. In order to improve accuracy, the position system 505 may implement at least two antennas 545. In some embodiments, the components of the positioning system 505 may be mounted or coupled to a main frame of the power machine 405. As one example, when the positioning system 505 includes two antennas 545, each antenna 545 may be mounted to a front portion of the main frame of the power machine 405, such as one antenna 545 near a front left wheel of the power machine 405 and another antenna 545 near a front right wheel of the power machine 405.

As described above with respect to the work elements 130 of FIG. 1, the work element 510 may be configured to perform a work task or operation, such as, for example, a mowing operation or task. In some embodiments, one example, of a work element 510 is a mower deck with one or more rotating blades that can be powered to perform a cutting operation (e.g., at different blade speeds or deck heights). The work element 510 may be attached or mounted to a main frame of the power machine 405 (e.g., the frame 110 of FIG. 1). For example, the work element 130 may be supported by a deck support assembly (e.g., the deck support assembly 232 of FIG. 2) relative to the main frame of the power machine 405.

In some embodiments, the work element 130 is movable with respect to the frame when performing a work task (e.g., a mowing event). Via selective adjustment of the deck support assembly, for example, the work element 510 may be configured to function at different cutting heights, angles, and the like.

As described in greater detail below, the work element 510 may be controlled by the control system 515 (for example, via one or more control signals received from the control system 515). As one example, a rotational speed of the one or more rotating blades may be controlled based on a control signal received from the control system 515. As another example, a height of the mowing deck and, ultimately, of the rotating blades, may be controlled based on a control signal received from the control system 515. Accordingly, in some embodiments, the work element 510 is associated with an actuator (not illustrated), such as a linear actuator.

As illustrated in FIG. 5, the power machine 405 also includes the tractive system 525 (e.g., the tractive system 240 of FIG. 2), which is configured to propel the power machine 405 over terrain or, more generally, a support surface. In the illustrated example, the tractive system 525 includes a set of speed sensors (e.g., a first speed sensor 550A and a second speed sensor 550B) and a set of wheels (e.g., a first wheel 555A and a second wheel 555B) (for example, the tractive elements 140 of FIG. 1). As similarly described above with respect to the powered wheels 242A and 242B of FIG. 2, the wheels 555A, 555B may be powered by a power system of the power machine 405 (for example, the power system 220 of FIG. 2). The speed sensors 550A, 550B are configured to collect (e.g., detect) speed data for a corresponding one of the wheels 555A, 555B. Accordingly, each speed sensor 550A, 550B can be associated with one of the wheels 555A, 555B (as represented in FIG. 5 by a dashed box). In the example illustrated in FIG. 5, the first speed sensor 550A is associated with the first wheel 555A and the second speed sensor 550B is associated with the second wheel 555B, although other configurations are possible. The communication system 520 includes a machine communication interface 560, which allows the power machine 405 (e.g., one or more components thereof) to communicate with devices external to the power machine 405. As one example, referring also to FIG. 4, the power machine 405 may communicate with the user device 415 through the machine communication interface 560. The machine communication interface 560 may include a port for receiving a wired connection to an external device (e.g.,, a universal serial bus (“USB”) cable and the like), a transceiver for establishing a wireless connection to an external device (e.g.,, over one or more communication networks 420, such as the Internet, local area network (“LAN”), a wide area network (“WAN”), and the like), or a combination thereof. As described in greater detail below, in some embodiments, the power machine 405 may transmit data to or receive data from the user device 415 via the communication system 520, including a list of coordinates associated with a bounding polygon of the geographical area (e.g., a list of GPS coordinates sufficient to specify a boundary of the geographical area, as gathered by a separate handheld device or otherwise) or other parameter that specifies part or all of a boundary of the geographical area, a list of positional coordinates associated with one or more known objects within the geographical area (e.g., a list of GPS coordinates of known object(s), as gathered by a separate handheld device or otherwise), a starting location (e.g., a starting point of a mowing event, a work path, etc.), an ending location (e.g., an ending point of a mowing event, a work path, etc.), one or more mowing event parameters (e.g., a desired mowing direction, as a compass bearing, a height, etc.), or another type of user input received via the user device 415, and the like. In such embodiments, one or more operations of the power machine 405 may be controlled (via one or more control signals generated by the control system 515) based on the operator inputs received at the user device 415.

The object detection system 526 provides object (or obstacle) detection functionality that detects objects, such as, e.g., objects positioned along a work path of the power machine 405. In the illustrated example, the object detection system 526 includes one or more object detection sensors 565 (referred to herein collectively as “the object detection sensors 525” and individually as “the object detection sensor 565”). The object detection sensor 565 may include, for example, a LIDAR sensor, a radar sensor, an ultrasonic sensor, or the like for detecting the presence of an object (e.g., as object data). The object detection sensors 565 may be positioned or coupled to the main frame of the power machine 405 at various locations, including on a front portion of the main frame (e.g., as shown for sensors 270 in FIG. 2) to detect objects that are ahead of the power machine 405 relative to a forward direction of travel.

The control system 515 (e.g., the control system 160 of FIG. 1) is configured to receive operator input or other input signals (e.g., sensor data, such as the speed data, the position data, the object data, or a combination thereof) and to output commands accordingly to control operation of the power machine 405. For example, the control system 515 can communicate with other systems of the power machine 405 to perform various work tasks, including to control tractive and implement actuators for travel and cutting operations over the course of a mowing event. In some embodiments, the control system 515 receives input from an operator input device, such as one of the operator input devices 262 of FIG. 2, including input as command signals provided by an operator of the power machine 405 via the operator input device. In response to receiving the input, the control system 515 may control the power machine 405 to perform a work task based at least in part on the input received from the operator input device.

Alternatively or in addition, as noted above, the control system 515 can be configured to complete one or more work tasks without specific, direct input from an operator (e.g., manipulation of the one or more operator input devices 262). Correspondingly, the control system 515 may be configured for automatic (e.g., automated) control of certain operations of the power machine 405. As one example, the control system 515 may include wireless communication capabilities (for example, via the communication system 520) so as to receive control commands or other relevant data from remotely located (i.e., not mechanically tethered) and other systems. In some such embodiments, the control system 515 can be configured to operate the power machine 405 in different control modes, with different levels of automatic control. For example, in a remote-control operation mode, the control system 515 can communicate with a remote user device so that an operator may provide real-time (or near real-time) control commands for controlling the power machine 405 (e.g., directional commands, speed commands, and the like). Alternatively, or in addition, the power machine 405 can function in some modes as an automatic power machine (e.g., in an automated operation mode).

As one example, in some embodiments, an operator may select (via, for example, the user device 415) a work path or route for performing a mowing event associated with a geographical area. The control system 515 may receive the selection (via, for example, the communication system 520 through the communication network 420) and control the power machine 405 such that the power machine 405 travels along the work path, including to complete one or more mowing events for the geographical area.

As another example, in some embodiments, an operator may provide user input associated with performing a mowing event associated with a geographical area, as described in greater detail below. The control system 515 may receive the user input (via, for example, the communication system 520 through the communication network 420), determine a work path based at least in part on the user input, and control the power machine 405 such that the power machine 405 travels along the work path, including to complete one or more mowing events for the geographical area.

As yet another example, in some embodiments, the control system 515 may receive object data from the object detection system 526 indicating that an object (or obstacle) is positioned along a work path being traversed by the power machine 405. In response to detecting the object, the control system 515 may determine a new work path for the power machine 405, as described in greater detail below.

As illustrated in FIG. 5, the control system 515 includes a controller 580. FIG. 6 illustrates the controller 580 according to some embodiments. In the illustrated example of FIG. 6, the controller 580 includes an electronic processor 600 (for example, a microprocessor, an application-specific integrated circuit (“ASIC”), or another suitable electronic device), a memory 605 (for example, a non-transitory, computer-readable medium), and a communication interface 610. The electronic processor 600, the memory 605, and the communication interface 610 communicate over one or more communication lines or buses. It should be understood that the controller 580 may include additional components than those illustrated in FIG. 6 in various configurations and may perform additional functionality than the functionality described herein. For example, in some embodiments, the functionality described herein as being performed by the controller 580 may be distributed among other components or devices.

The communication interface 610 allows the controller 580 to communicate with devices external to the controller 580. For example, as illustrated in FIG. 5, the controller 580 may communicate with the positioning system 505, the work element(s) 510, the tractive system 525, the communication system 520, the object detection system 526, or a combination thereof through the communication interface 610. The communication interface 610 may include a port for receiving a wired connection to an external device (for example, a universal serial bus (“USB”) cabled and the like), a transceiver for establishing a wireless connection to an external device (for example, over one or more communication networks, such as the Internet, local area network (“LAN”), a wide area network (“WAN”), and the like), or a combination thereof. In some embodiments, the controller 580 can be a dedicated or stand-alone controller. In some embodiments, the controller 580 can be part of a system of multiple distinct controllers (e.g., a hub controller, drive controller, workgroup controller, etc.) or can be formed by a system of multiple distinct controllers (e.g., also with hub, drive, and workgroup controllers, etc.).

The electronic processor 600 is configured to access and execute computer-readable instructions (“software”) stored in the memory 605. The software may include firmware, one or more applications, program data, filters, rules, one or more program modules, and other executable instructions. For example, the software may include instructions and associated data for performing a set of functions, including the methods described herein.

As one example, as illustrated in FIG. 6, the memory 605 may store a work path planning application 625 (referred to herein as “the application 625”). Alternatively or in addition, in some embodiments, the application 625 may be stored remotely, such as, for example, in a memory of the user device 415 or another remote device or database, such that the application 625 is accessible by the controller 580.

The application 625 is a software application executable by the electronic processor 600. As described in greater detail below, the electronic processor 600 may execute the application 625 for determining one or more work paths for the power machine 405. As one example, the electronic processor 600 may execute the application 625 to access user input associated with a geographical area and generate a work path based on at least the user input. Alternatively or in addition, the electronic processor 600 may execute the application 625 to control the power machine 405 to perform a series of operations or maneuvers such that the power machine 405 traverses a work path (for example, travel between the set of points forming the work path). Alternatively or in addition, in some embodiments, the electronic processor 600 may execute the application 625 to determine a new work path in response to detecting an object in or along a current work path being traversed by the power machine 405.

Referring also again to FIG. 4, the user device 415 may be used by an operator of a power machine 405 to provide user input associated with a geographical area. Further, in some embodiments, one or more elements of the control system of the power machine 405 (see, e.g., FIG. 5) can be included in or controlled by the user device 415. As one example, in some embodiments, the user device 415 may store the application 625.

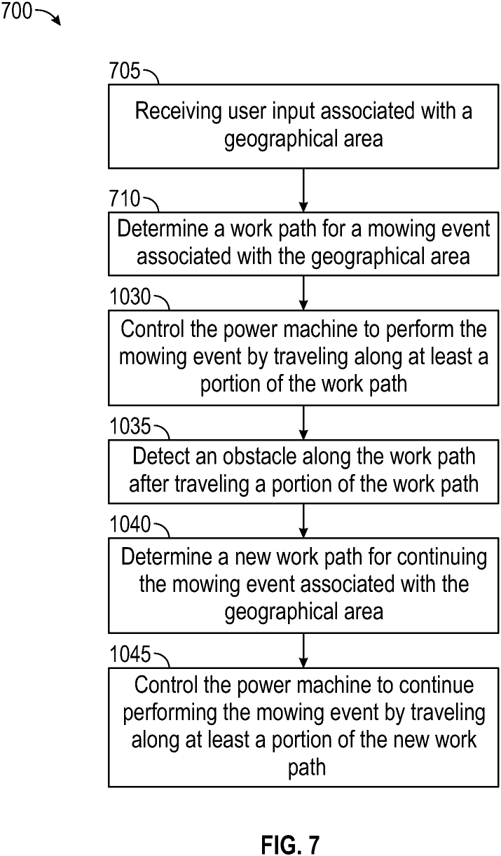

FIG. 7 is a flowchart illustrating a method 700 for controlling a power machine (for example, the power machine 405) performed by the system 400 according to some embodiments. In some embodiments, the method 700 can be performed by the control system 515 (e.g., the controller 580) and, in particular, the application 625 as executed by the electronic processor 600. However, as noted above, the functionality described with respect to the method 700 may be performed by other devices, including the user device 415, or can be distributed among a plurality of devices or components.

As illustrated in FIG. 7, at block 705, the method 700 includes receiving, with the electronic processor 600, user input associated with a geographical area. The electronic processor 600 may receive the user input from the user device 415 over the communication network 420. Alternatively or in addition, the electronic processor 600 may receive the user input via a component of the power machine 405, such as one of the operator input devices 262 of FIG. 2. The user input may include, e.g., a list of coordinates associated with a bounding polygon of the geographical area (e.g., a list of GPS coordinates sufficient to specify a boundary of the geographical area) or other parameter that specifies part or all of a boundary of the geographical area, a list of positional coordinates associated with one or more known objects within the geographical area (e.g., a list of GPS coordinates of known object(s)), a starting location (e.g., a starting point of a mowing event, a work path, etc.), an ending location (e.g., an ending point of a mowing event, a work path, etc.), one or more mowing event parameters (e.g., a desired mowing direction, as a compass bearing, a height, etc.), or another type of user input associated with performing a mowing event associated with a geographical area. A geographical area may include, e.g., part or all of backyard, a field, a sports field, a highway ditch, a park, etc.

In some embodiments, operations to identify a relevant boundary or other parameter of a geographic area may not necessarily include receiving user input associated with the geographic area. For example, boundaries and other parameters of geographic areas that can be associated with the method 700 can be determined based on previously stored geographic data (e.g., as autonomously or otherwise gathered) or can be determined based on real-time local (or other) sensor inputs.

The electronic processor 600 may determine a work path for a mowing event associated with the geographical area (at block 710). In some embodiments, the electronic processor 600 determines the work path based on the user input. In some embodiments, the electronic processor 600 performs pre-processing on the user input (or, e.g., other relevant geographical data) as part of determining the work path. The pre-processing may include performing a cellular decomposition with respect to a geographical area, resulting in a set of unordered cells. As appropriate, an order for the set of unordered cells can then be determined (e.g., by solving a traveling salesman problem with respect to the set of unordered cells), resulting in a set of ordered cells, and determining the work path based on the set of ordered cells.

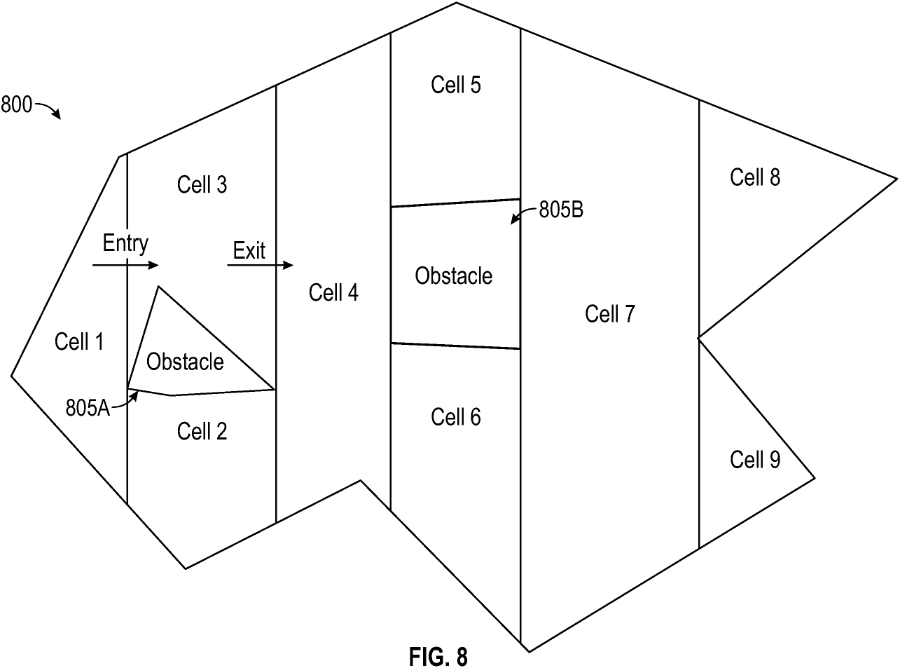

In some implementations, the electronic processor 600 may perform cellular decomposition of the geographical area by decomposing (or dividing) the geographical area into a set of cells, where each cell included in the set of cells does not include an object (e.g., each cell is object free). In different embodiments, different approaches for cellular decomposition are possible, including various known techniques. In some embodiments, the electronic processor 600 performs a boustrophedon cell decomposition analysis on the geographical area that transforms the geographical area into a set of cell regions. FIG. 8 illustrates an example geographical area 800 decomposed into a set of cells according to some embodiments. In the illustrated example, the geographical area includes a first object 805A and a second object 805B. As illustrated in FIG. 8, none of the cells include the first object 805A or the second object 805B. Rather, as illustrated in FIG. 8, the objects form a border of one or more cells (as opposed to being contained or included within a cell). In the illustrated example, the first object 805A helps form a border of Cell 1, Cell 2, and Cell 3 and the second object 805B helps form a boarder of Cell 4, Cell 5, Cell 6, and Cell 7.

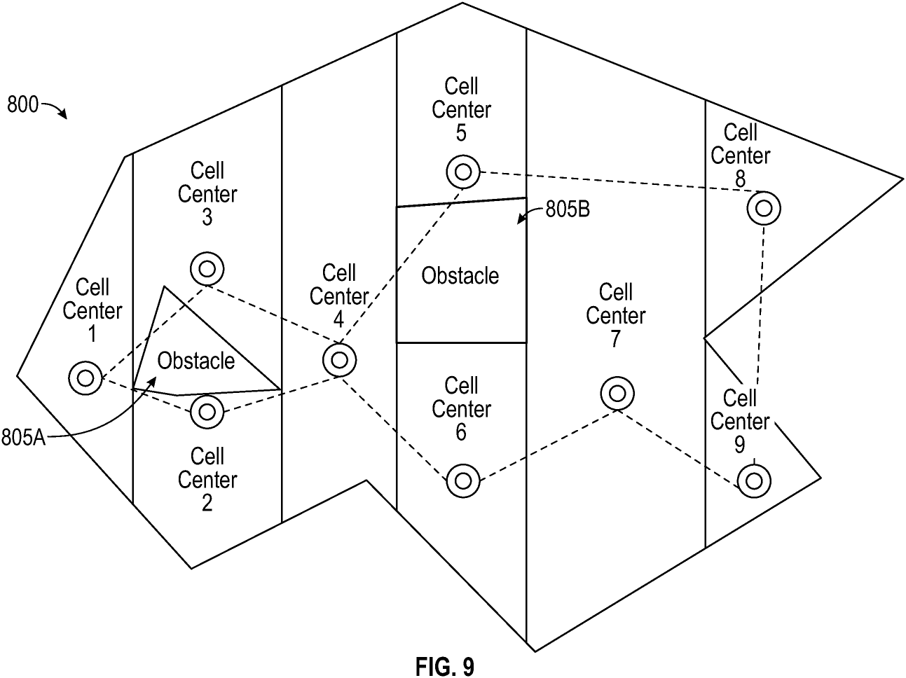

After performing the cellular decomposition of the geographical area and determining the set of cells (unordered cells), the electronic processor 600 may determine an order of the set of cells. In some embodiments, the electronic processor 600 determines the order by performing a traveling salesman problem analysis on the geographical area. The electronic processor 600 may determine a center position of each cell and recursively find the shortest path that visits each cell (i.e., each center position of each cell), as illustrated in FIG. 9 with respect to the geographical area 800 of FIG. 8.

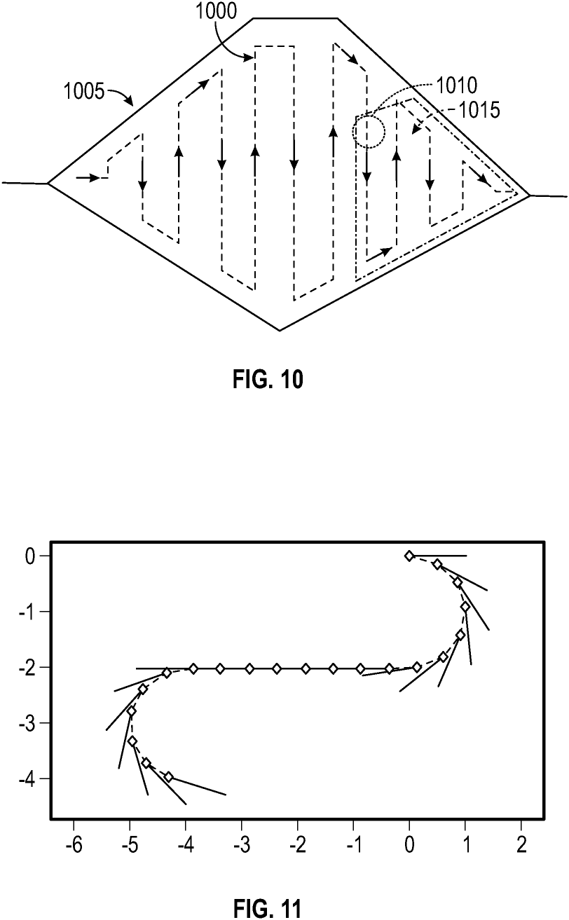

The electronic processor 600 may then perform intracellular path planning for each cell. As one example, in some embodiments, the electronic processor 600 determines an intracellular path for each cell included in the ordered set of cells. FIG. 10 illustrates an example intracellular path 1000 for a cell 1005 according to some embodiments. As illustrated in the example of FIG. 10, the intracellular path 1000 includes a back-and-forth pattern with overlapping spacing (e.g., as specified by a user as a mowing event parameter). In some embodiments, as illustrated in FIG. 11, the lines included in the intracellular path may be joined by Dubins curves. As also illustrated in FIG. 10, the intracellular path 1000 includes a pattern of travel within the cell 1005 such that the power machine 405 traverses the entire cell 1005.

As further discussed below, intentional departure from the path 1000 can be determined during some operations of the power machine 405. For example, based on radar (or other) detection of an unknown object 1010, an updated path for travel can be determined accordingly, including via automatic determination of a new path only for the un-mowed sub-area 1015 included within the larger cell 1005 as similarly discussed below.

In some embodiments, the electronic processor 600 determines the work path by connecting each intracellular path associated with the set of cells based on the order of the set of cells, such that the combined intracellular paths form the work path (as determined at block 710 of FIG. 7).

Referring again to FIG. 7, after determining the work path for the mowing event associated with the geographical area (at block 710), the electronic processor 600 may control the power machine 405 to perform the mowing event by traveling along at least a portion of the work path (at block 1030). The electronic processor 600 may generate and transmit one or more appropriate control signals for controlling the power machine 405 such that the power machine 405 travels along at least a portion of the work path. For example, the electronic processor 600 may generate and transmit a set of control signals to the tractive system 525, the work element(s) 510, or another component of the power machine 405 (e.g., to implement non-turning travel or turning travel, to raise or lower a mower deck, to rotate one or more cutting elements, etc.). In some embodiments, control of travel along a work path may include control to adjustment a parameter of the work element 510, such as a rotary speed, a deck height or angle, etc.

As illustrated in FIG. 7, the electronic processor 600 may detect an object along the work path after traveling a portion of the work path (at block 1035), including, for example, an unknown object. The portion of the work path may be associated with a subsection of the geographical area (e.g., a subsection of the geographical area that was traveled by the power machine 405, such as the region outside of the area 1015 in FIG. 11).

In some embodiments, the electronic processor 600 detects the unknown object based on object data received from the object detection system 526 (or one or more object detection sensors 565 therein). As noted above with respect to FIG. 5, the object detection system 526 provides object (or obstacle) detection functionality that detects objects, such as, e.g., objects positioned along a work path of the power machine 405. Accordingly, in some embodiments, the electronic processor 600 (e.g., the control system 515) may receive object data from the object detection system 526 indicating that an object (or obstacle) is positioned along the work path being traversed by the power machine 405 (e.g., the work path determined at block 710 of FIG. 7).

In response to detecting the unknown object (at block 1035), the electronic processor 600 may determine a new work path for continuing the mowing event (e.g., a second work path) (at block 1040). The new work path (or second work path) may be associated with a subsection of the geographical area remaining after the power machine 405 travels along the portion of the first work path (e.g., a remaining portion of the geographical area with portions of the first work path that have not yet been traveled when the power machine 405 detects the object). In some embodiments, the electronic processor 600 determines the new work path as similarly described above with respect to the work path determined at block 710, with respect to an entire geographical area. However, in some embodiments, the electronic processor 600 determines the new work path based on (or for) a remaining portion of the geographical area not yet traveled or other sub-area of the geographical area (e.g., the area 1015 in FIG. 10, only cell 5 through cell 9 in FIG. 9, etc.). The electronic processor 600 may determine the new work path based on data associated with the traveled portion of the geographical area, data associated with travelling along the traveled portion of the geographical area, the user input, the object data, or the like. For example, the electronic processor 600 may determine the new work path based on an actual or expected position of the mower after the mower has circumvented a detected (or other) object. In this regard, for example, a path that a mower travels for object avoidance can beneficially inform an updated mowing path that the mower takes thereafter, both to optimize further travel distances and ensure that an entire relevant area is covered by the mowing path in total. Thus, for example, some implementations can allow for determination of an efficient a path to mow an entirety of a geographical area, minus known obstacles or other designated avoidance zones (i.e., areas that are designated by a user for no mowing or that are otherwise predetermined to be excluded from mowing)

After determining the new work path (at block 1040), the electronic processor 600 controls the power machine 405 to continue performing the mowing event by traveling along at least a portion of the new work path (at block 1045). The electronic processor 600 may perform block 1045 as similarly described above with respect to block 1030 such that the power machine 405 is controlled to travel along at least a portion of the new work path.

In some embodiments, the electronic processor 600 (via the object detection system 526 and the one or more object detection sensors 565 therein) continuously monitors for unknown objects while the power machine 405 is travelling along a work path. Accordingly, the electronic processor 600 may repeat one or more blocks of FIG. 7. As one example, when the electronic processor 600 detects additional unknown objects, the electronic processor 600 may determine another work path and control the power machine 405 to travel along at least a portion of that another work path.

In some embodiments, after determining the work path, the electronic processor 600 can implement a path tracking module (e.g., as part of the application 625), including a localization module and a mapping module based on sensor data (e.g., position data collected by the positioning system 505, object data collected by the object detection system 526, or the like). In some embodiments, the path tracking module is implemented as part of controlling the power machine 405 to travel along a work path. As one example, the work path may be provided to the path tracking module. The path tracking module may determine commands for controlling the power machine 405. The path tracking module may determine the commands based on, e.g., the work path, a current position of the power machine 405, the user input, or the like. In some embodiments, the path tracking module implements a “pure pursuit” approach. Alternatively or in addition, the path tracking module may implement a state estimation approach that estimates a pose of the power machine 405 (e.g., an x position, a y position, and a heading) by fusing position data (e.g., GPS measurements) with an output of a motion model (via, e.g., the positioning system 505).

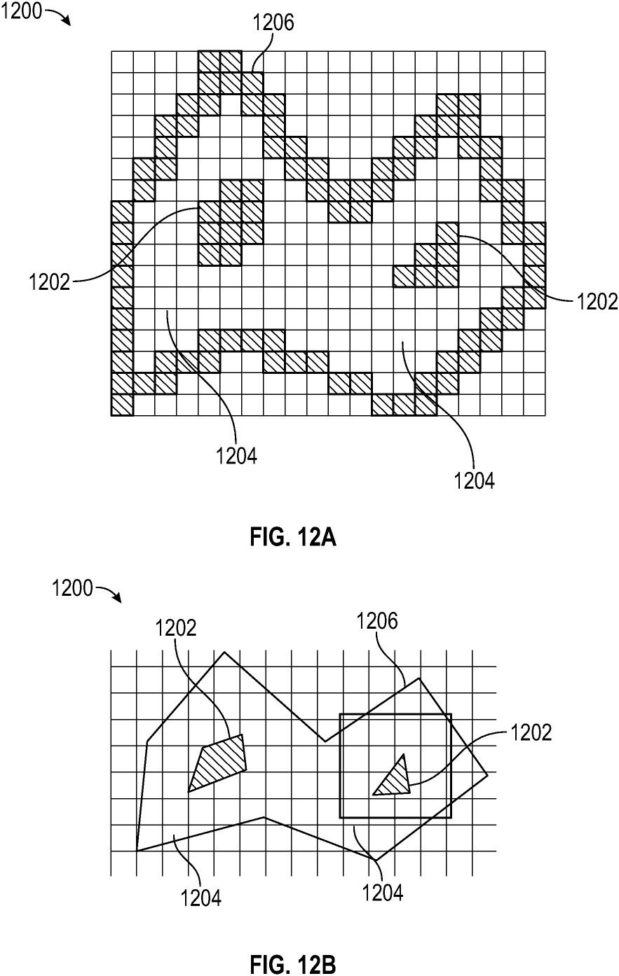

Alternatively or in addition, in some embodiments, the path tracking module generates a map or grid map associated with the geographical area. FIGS. 12A-12B illustrate example grid maps 1200 associated with a geographical area. As illustrated in the example grid maps 1200 of FIGS. 12A-12B, the geographical area can be divided into a plurality of grid cells of various sizes. The grid maps 1200 may be populated using data from one or more sensors or systems of the power machine 405, such as, e.g., data from the positioning system 505, data from the object detection system 526, or the like. The grid map 1200 may be populated by indicating whether a grid cell is an obstacle (e.g., object) or a free space (e.g., as shown relative to obstacles 1202 and free spaces 1204), as well as to include any workspace or other boundaries (e.g., as shown relative to mowing boundary 1206). The grid map 1200 may be populated as the power machine 405 travels along a work path.

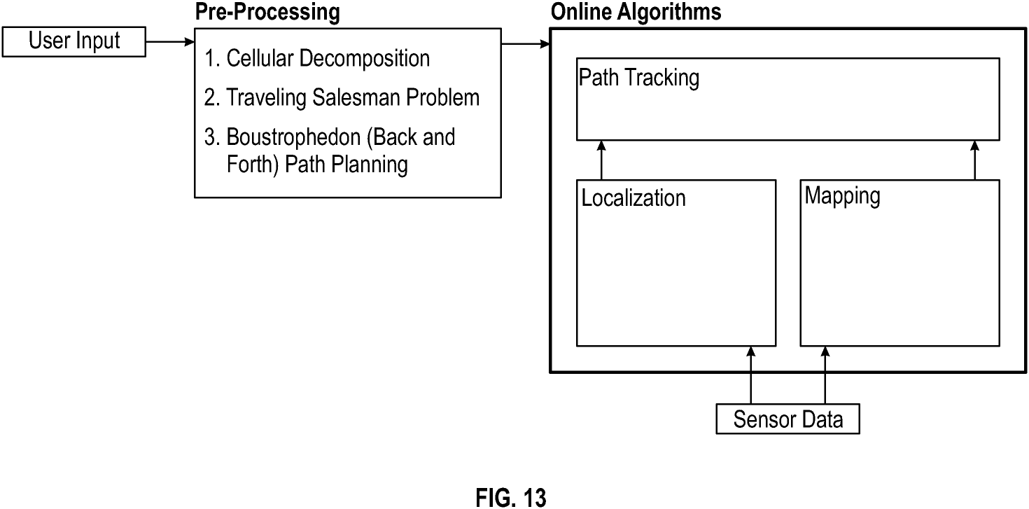

Alternatively or in addition, in some embodiments, the embodiments described herein may be implemented using the example architecture illustrated in FIG. 13. As one example, the example architecture illustrated in FIG. 13 may be implemented by the application 625.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise expressly limited or defined, the term “automatic operations” refers to operations that are at least partly dependent on electronic application of computer algorithms for decision-making without human intervention. In this regard, unless otherwise expressly limited or defined, “automatic travel” refers to travel of a power machine or other vehicle in which at least some decisions regarding steering, speed, distance, or other travel parameters are made without direct intervention by a human operator. Relatedly, the term “automated operations” (and the like), unless otherwise expressly limited or defined, refers to a subset of automatic operations for which no intervention by a human operator is required. For example, automated travel can refer to automatic travel of a power machine or other vehicle during which steering, speed, distance, or other travel parameters are determined in real time without operator input. In this regard, however, operator input may sometimes be received to start, stop, interrupt, or define parameters (e.g., top speed) for automated travel or other automated operations.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGs. or otherwise discussed herein. Unless otherwise specified or limited, representation in the FIGs. of particular operations in particular spatial order may not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Although the present invention has been described with reference to preferred embodiments, workers skilled in the art will recognize that changes may be made in form and detail to the disclosed embodiments without departing from the spirit and scope of the concepts discussed herein.

What is claimed is:

1. A method of controlling a power machine, the method comprising:
determining, with an electronic processor, a first work path for a mowing event associated with a geographical area;
controlling, with the electronic processor, the power machine to perform the mowing event by traveling along at least a portion of the first work path;
detecting, with the electronic processor based on receiving sensor signals, a first unknown object along the first work path after traveling a first portion of the first work path, wherein the first portion is associated with a first subsection of the geographical area;
determining, with the electronic processor, a second work path for continuing the mowing event, the second work path associated with a second subsection of the geographical area remaining after the power machine travels along the first portion of the first work path; and
controlling, with the electronic processor, the power machine to continue performing the mowing event by traveling along at least a portion of the second work path.

2. The method of claim 1, further comprising:
detecting a second unknown object along the second work path after traveling a second portion of the second work path, wherein the second portion is associated with a third subsection of the geographical area;
determining a third work path for continuing the mowing event, the third work path associated with a third subsection of the geographical area remaining after the power machine travels along the first portion of the first work path and the second portion of the second work path; and
controlling the power machine to continue performing the mowing event by traveling along at least a portion of the third work path.

3. The method of claim 1, wherein determining the first work path includes accessing a user input associated with at least one of: a known object within the geographical area, a boundary parameter for the geographical area, a starting point of the mowing event, an ending point of the mowing event, or at least one parameter of the mowing event.

4. The method of claim 1, wherein determining the first work path includes:
decomposing the geographical area into a first set of cells, wherein each cell included in the first set of cells does not include an object; and
determining the first path based on the first set of cells.

5. The method of claim 4, wherein determining the first work path includes:
determining an order of the first set of cells based on a shortest path between each cell included in the first set of cells; and
determining the first path based on the order of the first set of cells,
wherein controlling the power machine to perform the mowing event by traveling along the first work path includes controlling the power machine to travel along the first work path based on the order of the first set of cells, wherein the power machine travels in a first direction along the first work path by traveling successively to each cell included in the first set of cells based on the order of the first set of cells.

6. The method of claim 4, wherein determining the first path based on the first set of cells includes determining an intracellular path for each cell included in the first set of cells;
wherein controlling the power machine to perform the mowing event by traveling along the first work path includes controlling the power machine to perform the mowing event by traveling along each intracellular path associated with the first set of cells based on the order of the first set of cells; and
wherein determining the intracellular path includes determining a pattern of travel within a cell included in the first set of cells such that the power machine entirely traverses the cell.

7. The method of claim 1, wherein detecting the first unknown object includes:
while the power machine travels along the first work path, receiving sensor data associated with the power machine, and
detecting the first unknown object based on the sensor data.

8. A power machine comprising:
a main frame;
a work element coupled to the main frame;
a plurality of electrical actuators coupled to the main frame;
an electrical power source configured to power the plurality of electrical actuators; and
an electronic controller in communication with the plurality of electrical actuators, the electronic controller configured to:
control the power machine to perform a mowing event associated with a geographical area by traveling along at least a portion of a first work path determined for the geographical area;
detect, based on receiving sensor signals, a first unknown object along the first work path after the power machine travels a first portion of the first work path, wherein the first portion is associated with a first subsection of the geographical area;
determine a second work path for continuing the mowing event, the second work path associated with a second subsection of the geographical area remaining after the power machine travels along the first portion of the first work path; and
control the power machine to continue performing the mowing event by traveling along at least a portion of the second work path.

9. The power machine of claim 8, wherein the electronic controller is further configured to:
access user input associated with the geographical area, and
determine, based on the user input, the first work path for the mowing event associated with the geographical area.

10. The power machine of claim 8, wherein the electronic controller is configured to determine the first work path for the mowing event associated with the geographical area by:
decomposing the geographical area into a first set of cells, wherein each cell included in the first set of cells is object free; and
determining the first path based on the first set of cells.

11. The power machine of claim 10, wherein the electronic controller is configured to determine the first work path for the mowing event associated with the geographical area by:
determining an order of the first set of cells based on a shortest path between each cell included in the first set of cells; and
determining the first path based on the order of the first set of cells,
wherein the electronic controller is configured to control the power machine to perform the mowing event by traveling along the first work path by controlling the power machine to travel along the first work path based on the order of the first set of cells, wherein the power machine travels in a first direction along the first work path by traveling successively to each cell included in the first set of cells based on the order of the first set of cells.

12. The power machine of claim 11, wherein the electronic controller is configured to determine the first path based on the first set of cells by determining an intracellular path for each cell included in the first set of cells.

13. The power machine of claim 12, wherein the electronic controller is configured to control the power machine to perform the mowing event by controlling the power machine to travel along each intracellular path associated with the first set of cells, based on the order of the first set of cells.

14. The power machine of claim 8, wherein the electronic controller is configured to determine the second work path for continuing the mowing event by:
decomposing the second subsection of the geographical area into a second set of cells, wherein each cell included in the second set of cells is object free; and
determining the second path based on the second set of cells.

15. The power machine of claim 14, wherein the electronic controller is configured to determine the second work path for continuing the mowing event by:
determining an order of the second set of cells based on a shortest path between each cell included in the second set of cells; and
determining the second path based on the order of the second set of cells.

16. The power machine of claim 8, wherein the electronic controller is configured to:
detect a second unknown object along the second work path after traveling a second portion of the second work path, wherein the second portion is associated with a third subsection of the geographical area,
determine a third work path for continuing the mowing event, the third work path associated with a third subsection of the geographical area remaining after the power machine travels along the first portion of the first work path and the second portion of the second work path, and
control the power machine to continue performing the mowing event by traveling along at least a portion of the third work path.

17. The power machine of claim 16, wherein the third subsection of the geographical area is smaller than the second subsection of the geographical area and the second subsection of the geographical area is smaller than the first subsection of the geographical area.

18. The power machine of claim 16, wherein the first subsection of the geographical area includes the entirety of the geographical area.

19. A mower comprising:
a main frame;
a power source;
a cutting assembly coupled to the main frame and configured to be powered by the power source for cutting operations;
one or more drive motors coupled to the main frame and configured to be powered by the power source to move the mower over terrain during cutting operations;
a radar system arranged to monitor an area around the mower; and
an electronic controller in communication with the one or more drive motors and the radar system, the electronic controller configured to:
control the mower to perform a mowing event associated with a geographical area by traveling along at least a portion of a first work path determined for the geographical area;
detect, based on receiving signals from the radar system, a first unknown object along the first work path after the mower travels a first portion of the first work path, wherein the first portion is associated with a first subsection of the geographical area; and
after detecting the first unknown object, determine a second work path for continuing the mowing event beyond the first unknown object, the second work path associated with a second subsection of the geographical area remaining after the mower travels along the first portion of the first work path; and
control the mower to continue performing the mowing event by traveling along at least a portion of the second work path.

20. The mower of claim 19, wherein the first work path and the second work path collectively route the mower to mow an entirety of the geographical area, excluding known obstacles and designated avoidance zones.
